(19) United States
(12) Patent Application Publication
(10) Pub. No.: US 2026/0289235 A1
(43) Pub. Date: Sep. 24, 2026

(54) Quantum Modular Computing System with Modular AI, Subconscious Innovation, IoT Integration, and Global Connectivity

(71) Applicant: Gabriela Garcia, Murchison, TX (US)

(72) Inventor: Gabriela Garcia, Murchison, TX (US)

(21) Appl. No.: 19/018,717

(22) Filed: Jan. 13, 2025

(51) Int. Cl. G06N 3/045; G06N 10/20

(52) U.S. Cl. CPC G06N 3/045; G06N 10/20

(57) ABSTRACT

This quantum modular computing system enhances computational efficiency by integrating quantum computing, modular AI inspired by brain functions, subconscious innovation, IoT-driven global connectivity, and energy optimization. The system features a never-seen-before Cascading Neuro-Network Protocol (CNNP) for intelligent task delegation, a NeuroHub for modular orchestration, and a decentralized NeuroNetwork for real-time AI collaboration. An adaptive quantum scheduler and predictive cybersecurity enable scalable, high-performance processing with a projected 20% energy efficiency gain. The invention addresses gaps in Tesla's hardware scalability, Google's energy-intensive AI algorithms, and Intel's lack of decentralized architecture. Mimicking the human brain's 2-watt reasoning capacity, it establishes a new paradigm for quantum-AI convergence, offering unprecedented adaptability, security, and real-time intelligence across industries.

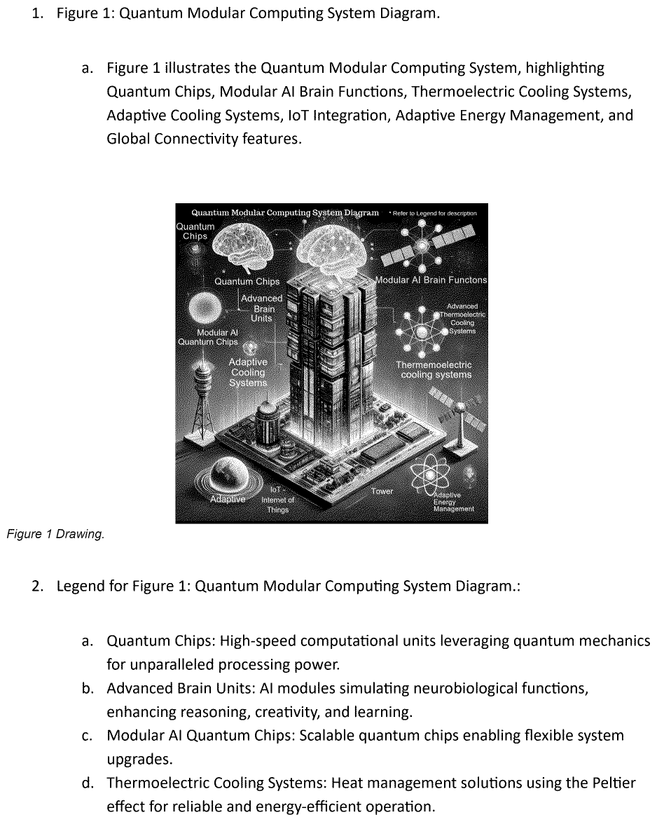

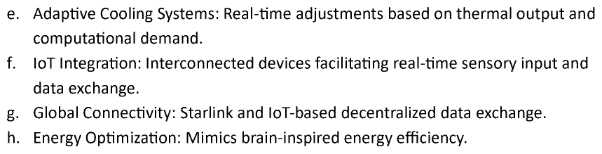

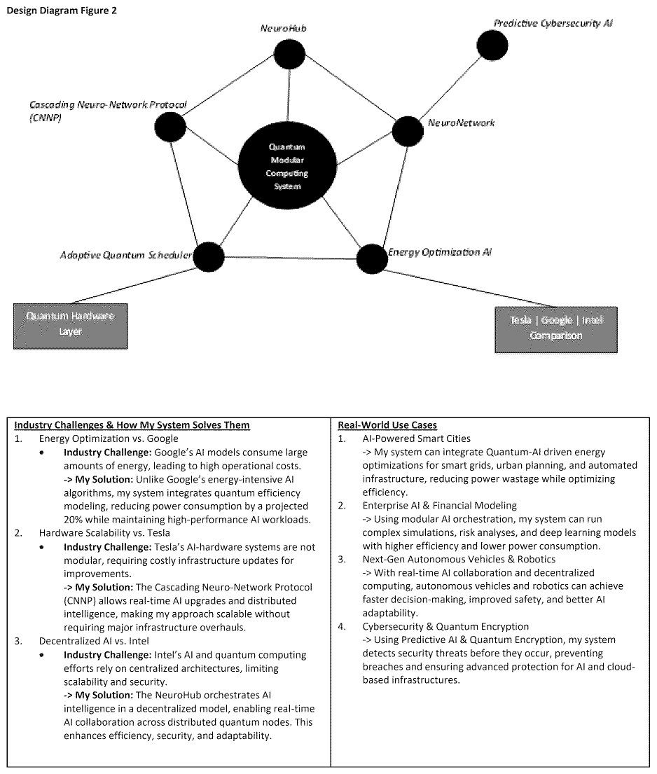

### IV. BACKGROUND

### a. Field of the Invention

This invention combines quantum computing, modular AI, IoT integration, advanced cooling, and adaptive cybersecurity to create a scalable and energy-efficient platform for diverse industries.

### V. CHALLENGES ADDRESSED

1. High energy consumption in AI systems (e.g., GPUs requiring 100+ watts).
2. Siloed AI and quantum computing technologies without modularity or scalability.
3. Inefficiencies in intermodular communication protocols.
4. Scalability limitations in centralized architectures.
5. Lack of integrated, adaptive cybersecurity solutions.

### VI. SUMMARY OF THE INVENTION:

1. Comprehensive AI System: Features 40+ modular AI systems inspired by human brain functions, with unique intermodular communication protocols.
2. IoT-Driven Connectivity: Integrates IoT devices as a distributed sensory network with global connectivity via satellites and cell towers.
3. Energy Optimization Inspired by the Brain: Projected to reduce power consumption by 20%, mimicking the human brain's efficiency through thermoelectric cooling and fasting-mode energy reserves.
4. Integrated Cybersecurity: Fear Response AI employs anomaly detection and real-time threat containment via Reflex AI, evolving firewall security to counter adaptive threats.
5. Scalability: Seamlessly adapts from small-scale smart homes to enterprise-level data centers through modular upgrades.
6. Gap-Filling Innovation: Bridges critical gaps in Tesla, Google, and Intel systems with unified modularity, energy-efficient scalability, and enhanced cybersecurity.

### II. DETAILED DESCRIPTION

### 1. AI Modules and Brain Functions

a. Detailed alignment of 40 AI functions with corresponding brain regions (see Appendix A).

### 2. Energy Optimization Systems

a. Thermoelectric cooling and adaptive energy reserves inspired by neurobiological efficiency.

### 3. Cybersecurity Enhancements

a. Dynamic, self-adaptive protocols informed by Fear Response AI and Reflex AI for real-time anomaly detection and immediate threat containment.

### 4. Scalability

a. Modular architecture supports scaling from IoT devices to enterprise-grade data centers.

### III. Addressing Competitor Gaps

a. Tesla: Modular AI enables adaptive solutions for industries like healthcare, aerospace, and disaster response.
b. Google: Advanced cooling systems are projected to reduce power consumption by 20%, enabling real-time IoT applications.
c. Intel: Combines quantum chips with Starlink and IoT for seamless global scalability, ideal for decentralized smart systems.

### IV. Applications

1. Healthcare: Combines Memory AI, Reasoning AI, and Emotional Intelligence AI to analyze patient data and propose personalized treatments.
2. Smart Cities: Manages urban IoT data for traffic optimization, energy distribution, and public safety.
3. Cybersecurity: Fear Response AI secures smart devices, critical infrastructure, and data centers.
4. Disaster Response: Reflex AI coordinates rescue operations using IoT sensors, conserving energy in fasting-mode reserves.
5. Aerospace: Enables reliable low-power systems for interstellar missions.

### V. Energy Efficiency Highlight

The human brain uses 2 watts for reasoning, compared to GPUs requiring 100+ watts. This system is projected to reduce power consumption by 20%, integrating adaptive cooling and fasting-mode reserves.

### VI. Expanded Connectivity: Operates Through IoT Mesh Networks, Starlink Satellites, and Cell Towers for Decentralized Global Operations. Seamlessly Integrates With Existing Smart Devices.

### VII. Novelty and Non-Obviousness of the Invention

### 1. Novelty

a. Energy Efficiency Mirroring Neurobiological Processes: The invention introduces a system mimicking the human brain's 2-watt reasoning capability, offering a projected 20% reduction in power consumption. Combines thermoelectric cooling and fasting-mode energy reserves to operate efficiently during low-demand periods while maintaining peak performance under high demand.
b. Brain-Inspired Modular AI Framework: Features over 40 AI modules mapped to specific brain regions, such as the Amygdala (fear detection) and the Prefrontal Cortex (long-term planning), to create a modular structure distinct from generic, task-oriented AI systems. Provides industry-specific modularity, enabling applications across healthcare, cybersecurity, aerospace, and smart cities.
c. Dynamic Cybersecurity System: Includes Fear Response AI for proactive threat detection and Reflex AI for immediate mitigation. Functions as a biological immune system analog, dynamically adapting to threats in real time, a capability absent in static or pre-configured cybersecurity systems.
d. IoT as a Peripheral Nervous System: IoT devices are integrated as sensory inputs, providing real-time feedback and adaptive responses, mirroring the role of the human peripheral nervous system in data collection and immediate action.

### 2. Non-Obvious Aspects

a. Synergistic Integration Across Domains: The invention seamlessly integrates quantum computing, modular AI, IoT, and energy systems into a unified platform. Unlike competitors focusing on isolated advancements (e.g., Google's AI or Tesla's energy optimization), it addresses interdisciplinary challenges through combined modularity and scalability.
b. Decentralized Global Connectivity: Starlink satellite integration enables seamless, decentralized data exchange for global scalability. The decentralized architecture addresses the limitations of Intel's neuron-emulation systems and Google's centralized data centers.
c. Adaptability Across Industries: The modular design allows dynamic scaling from consumer IoT devices to enterprise-grade quantum systems, offering unparalleled flexibility for diverse applications such as:
   Healthcare diagnostics.
   Smart city traffic optimization.
   Energy-efficient disaster response.
d. Biologically Inspired Cooling and Power Management:
   Advanced thermoelectric cooling systems are inspired by the brain's efficiency in managing heat and energy distribution.
   Unlike traditional cooling systems, this system optimizes performance through adaptive power allocation and energy conservation.
e. Holistic AI Ecosystem:
   The neuro-inspired design replicates brain functions while fostering intermodular communication through proprietary protocols, enhancing decision-making and problem-solving capabilities.
   Example: Collaboration between Creativity AI and Reasoning AI generates innovative solutions, surpassing the algorithmic focus of competitors.

### VIII. Competitor Gap Analysis

### 1. Tesla

a. Gap: Tesla's hardware-specific AI chips are limited to autonomous vehicles and energy storage.
b. Innovation: The modular AI system adapts across industries, offering scalable solutions for healthcare, aerospace, and smart cities.

### 2. Google

a. Gap: Google's energy-intensive AI lacks modularity and real-world IoT integration.
b. Innovation: The system's projected 20% energy efficiency and IoT-driven connectivity enable real-time applications with minimal energy demands.

### 3. Intel

a. Gap: Intel's neuromorphic chips focus narrowly on neuron emulation without scalability or quantum integration.
b. Innovation: Combining quantum chips with IoT and Starlink connectivity creates a decentralized system ideal for large-scale operations.

### IX. Supporting Use Cases

### 1. Healthcare

a. Example: Reasoning AI collaborates with Memory AI to analyze patient data, offering personalized treatment recommendations, which Intel's neuromorphic focus cannot achieve.

### 2. Smart Cities

a. Example: Predictive modeling using Pattern Recognition AI and Spatial Awareness AI optimizes traffic and energy distribution in real time, filling the gap left by Tesla's hardware-centric AI.

### 3. Cybersecurity

a. Example: Fear Response AI proactively detects threats, while Reflex AI instantly mitigates risks, surpassing Google's static data-focused models.

### X. Conclusion

This modular quantum computing system combines quantum chips, modular AI inspired by brain functions, IoT-driven energy optimization, and adaptive cybersecurity to redefine scalability and efficiency. It addresses critical gaps in Tesla, Google, and Intel technologies while pioneering energy-efficient innovation.

As highlighted in the Novelty and Non-Obviousness section, this invention's unique integration of energy-efficient, brain-inspired AI modules and modular quantum architecture offers unprecedented advancements in computational efficiency and real-world applicability. By mimicking the brain's 2-watt reasoning capacity, this system not only achieves breakthrough energy savings but also sets a new benchmark for scalability, functionality, and adaptability across industries.

This invention represents a significant leap in technological innovation, redefining how quantum computing, AI, and energy systems work together to solve real-world challenges.

### XI. Appendix A: Comprehensive AI Module Functions

1. Reasoning AI: Logical decision-making.
2. Memory AI: Contextual data storage and retrieval.
3. Creativity AI: Innovative problem-solving.
4. Reflex AI: Real-time monitoring and responses.
5. Sensory Integration AI: Multi-source input aggregation.
6. Fear Response AI: Threat detection and firewall adjustments. . . . (continued for all 40 functions)
7. Language Processing AI (Broca's/Wernicke's Area): Handles natural language communication.
8. Adaptability AI (Cerebellum): Continuous optimization.
9. Ethical Reasoning AI (Anterior Cingulate Cortex): Ensures moral decision-making.
10. Pattern Recognition AI (Occipital Lobe): Analyzes visual trends.
11. Spatial Awareness AI (Parietal Lobe): Processes spatial data.
12. Predictive Modeling AI (Temporal Lobe): Forecasts scenarios.
13. Learning AI (Basal Ganglia): Improves through reinforcement learning.
14. Autonomic Systems AI (Medulla Oblongata): Manages background processes.
15. Empathy and Social Understanding AI (Mirror Neurons): Processes social cues and simulates empathy.
16. Motivation and Reward AI (Nucleus Accumbens): Drives performance through simulated rewards.
17. Homeostasis AI (Hypothalamus): Maintains balance in thermal output and task prioritization.
18. Fear Response AI (Amygdala Subfunction): Detects anomalies or threats.
19. Attention AI (Reticular Activating System): Focuses resources on high-priority tasks.
20. Problem-Solving AI (Dorsolateral Prefrontal Cortex): Strategizes and solves complex multi-step problems.
21. Multitasking AI (Anterior Prefrontal Cortex): Manages simultaneous operations.
22. Long-Term Planning AI (Orbitofrontal Cortex): Develops adaptive strategic roadmaps.
23. Fine Motor Control AI (Primary Motor Cortex): Executes precise mechanical operations.
24. Pain Detection AI (Somatosensory Cortex): Identifies faults or inefficiencies.
25. Stress Management AI (HPA Axis Equivalent): Balances resource allocation under high demand.
26. Auditory Processing AI (Auditory Cortex): Interprets sound inputs for advanced audio recognition.
27. Conflict Resolution AI (Anterior Cingulate Cortex Subfunction): Manages competing processes.
28. System Calibration AI (Cerebellar Subsystems): Continuously tunes system parameters.
29. Curiosity and Exploration AI (Locus Coeruleus): Explores new strategies or methods.
30. Habit Formation AI (Basal Ganglia Subfunction): Automates repetitive tasks for efficiency.
31. Sleep and Recovery AI (Pineal Gland): Regulates low-power recovery cycles.
32. Emotional Regulation AI (Ventral Medial Prefrontal Cortex): Balances system responses.
33. Spatial Memory AI (Entorhinal Cortex): Maps and stores spatial data.
34. Vision and Perception AI (Occipital Cortex): Processes complex visual inputs.
35. Imagination AI (Temporal and Parietal Lobes Combined): Simulates scenarios for innovation.
36. System Adaptation AI (Neuroplasticity Simulation): Restructures pathways for efficiency.
37. Reward-Based Learning AI (Ventral Tegmental Area): Optimizes processes via reinforcement.
38. Decision Confidence AI (Insular Cortex):
39. Evaluates the confidence level of decisions or predictions to enhance reliability and trustworthiness.
40. Subconscious Processes AI (Default Mode Network):
41. Explores hypothetical scenarios and generates insights during idle cycles, simulating the brain's subconscious creativity.
42. Peripheral Integration AI (Spinal Cord Analogy):
43. Ensures seamless communication between centralized and peripheral systems, managing IoT interactions and external sensory inputs.

1. Comprehensive AI System: A modular AI framework inspired by human brain functions, encompassing 40+ specialized modules for reasoning, creativity, and sensory processing.

2. Addresses gaps in Tesla's hardware-focused AI systems by enabling interdisciplinary applications across healthcare, smart cities, and aerospace.

3. Intermodular Communications Protocols: Dynamic task allocation and seamless collaboration across AI modules, eliminating inefficiencies in data transfer and solving limitations in Intel's neuromorphic systems.

4. Peripheral Nervous System Analogy: IoT devices act as sensory inputs, integrating real-time data for distributed responsiveness. Addresses Tesla's lack of multi industry adaptability by extending AI applications to decentralized IoT networks.

5. Energy Optimization: Inspired by the brain's efficiency, the system combines thermoelectric cooling, adaptive power management, and fasting-mode reserves. Surpasses Google's resource-intensive AI algorithms by reducing power consumption by 20% (projected).

6. Integrated Cybersecurity System: Fear Response AI for anomaly detection, coupled with Reflex AI for immediate threat mitigation. Protects against evolving cybersecurity challenges, enhancing Google's limited real-time adaptability.

7. Global Connectivity: A decentralized network architecture leveraging Starlink satellites, IoT mesh networks, and cell towers. Bridges Intel's limitations in global scalability by ensuring seamless data integration and uninterrupted decentralized operations.
